(19) United States
(12) Patent Application Publication
(10) Pub. No.: US 2013/0326565 A1
(43) Pub. Date: Dec. 5, 2013

(54) SYSTEM AND METHOD FOR SUPPLYING INFORMATION TO A PLURALITY OF USERS DURING MASS EVENTS

(71) Applicant: Tim Goldburt, New York, NY (US)

(72) Inventor: Tim Goldburt, New York, NY (US)

(21) Appl. No.: 13/482,709

(22) Filed: May 29, 2012

(51) Int. Cl. H04N 21/20

(52) U.S. Cl. 725/74

(57) ABSTRACT

For supplying information to a plurality of users during mass events the users are given articles which are worn by them, and a remotely acting wireless control unit acts on electronic devices provided in the articles and having electronic displays, so that the corresponding information is provided on the displays in the form of video images, and the remotely acting wireless control unit can generate audio messages in audio components of the displays.

### BACKGROUND OF THE INVENTION

The present invention relates to systems and methods for supplying information to a plurality of users during mass events.

The systems and methods of the above mentioned general type are known in the art. During mass events, such as for example sports event on stadiums, conferences in conference halls, prayers in houses of prayers, etc. the information is transmitted to a plurality of people through telephone systems, public announcements, loudspeaker systems etc. Such systems and methods in many instances are expensive, complicated and inefficient. It is therefore believed that the existing systems and methods of this type can be further improved.

### SUMMARY OF THE INVENTION

Accordingly, it is an object of the present invention to provide a system and a method for supplying information to a plurality of people during mass events, which are further improvements of the existing systems and methods.

In keeping with these objects and with others which will become apparent hereinafter, one feature of the present invention resides, briefly stated, in that in accordance with the present invention a plurality of bracelets are worn by users, each bracelet is provided with an electronic device having a display, and means are provided for remotely acting on the electronic devices with the use of an internet so that video images which carry corresponding information are produced on the displays of the electronic devices of the bracelets.

In accordance with a further feature of the present invention each bracelet is provided with audio means which produce audio messages under the action of the remotely acting means which acts on the electronic devices of the bracelets.

In accordance with the present invention, the video images provided on the displays and the audio messages provided by the audio means of the bracelets can be relevant to each other so as to correspond to each other and/or accompany each other or alternatively can be irrelevant to each other.

In accordance with the present invention, the remotely acting means can include an internet-based control unit and a GPS communication unit, allowing to display the video images and to produce the audio messages at corresponding locations of the users who wear the bracelets.

Still a further feature of the present invention is that the bracelets have user-operated means, allowing to display the video images and/or produce audio messages not only under the action of the remotely acting means, but also by users view the user-operated means.

While the invention is defined in the appended claims, it will be best understood from the following description of the preferred embodiments, which is accompanied by the following drawings

### BRIEF DESCRIPTION OF THE DRAWINGS

FIG. 1 is a view schematically showing a system for supplying information to a plurality of users during a mass event in accordance with the present invention;

FIG. 2 is a view showing a bracelet of an inventive system, which is arranged on a wrist of a user;

FIG. 3 is a front view of the bracelet of the inventive system for supplying the information to a plurality of users; and

FIG. 4 is a schematic electronic circuit provided in a bracelet of the inventive system for providing information to a plurality of users.

### DESCRIPTION OF THE PREFERRED EMBODIMENTS

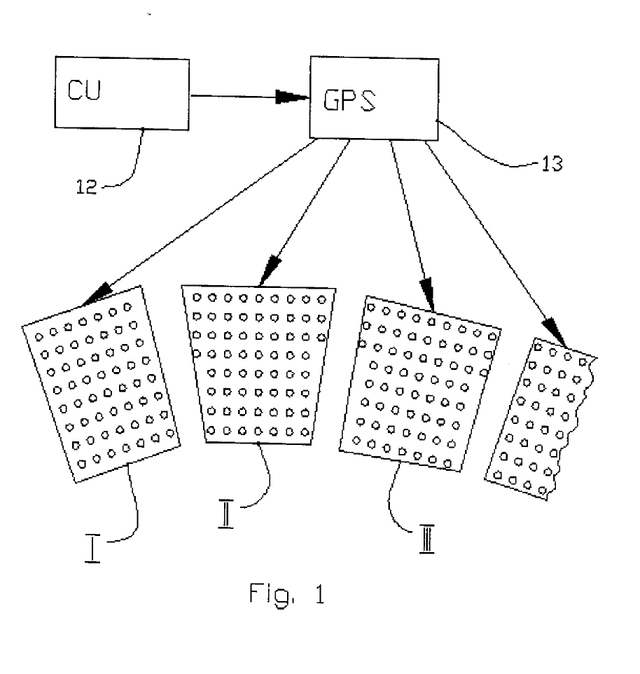

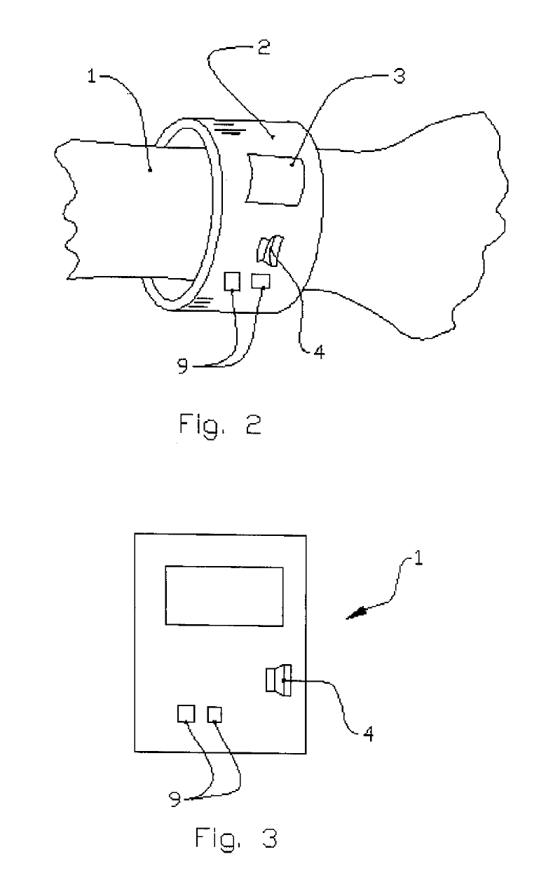

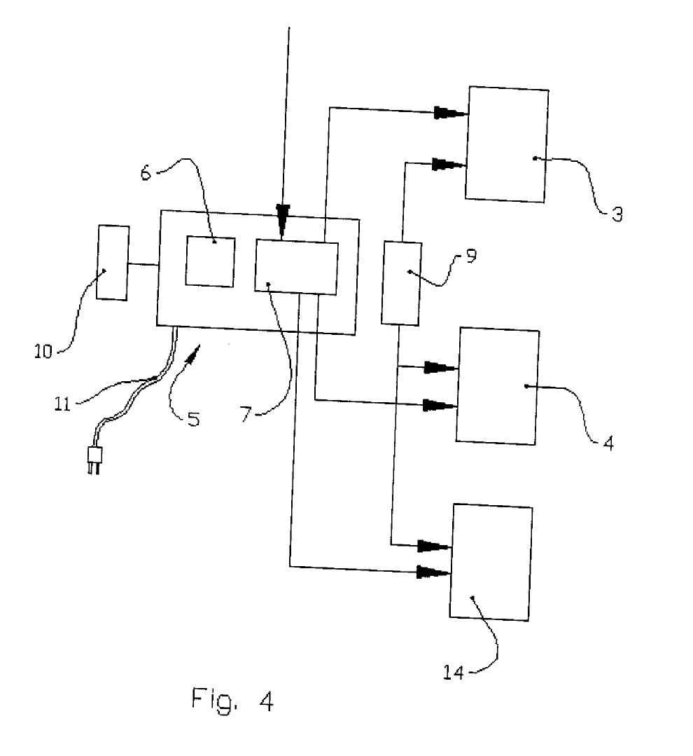

A system and a method for supplying information to a plurality of users during mass event can be used for example during a sport event in a stadium as shown in FIG. 1. A plurality of people or users 1 are seated in their seats located in corresponding sectors I, II, III etc in the stadium.

Each user 1 has a bracelet, or another article which he or she wears, identified as a whole with reference numeral 2, which the user 1 can wear on its wrist. Each bracelet 2 has an electronic display 3 which can be composed for example of a plurality of LEDs or OLEDs, and an audio unit 4 which can be formed for example as a speaker. The electronic display 3 can display video images which can be composed for example of a plurality of letters, numbers, symbols, and can be advertising images, proprietary images, informative images, decorative images, etc. The audio unit can produce audio messages which can be advertising announcement, informative speeches, music, etc.

In accordance with the present invention, the video images and the audio messages can be irrelevant to each other, or in other words they do not include logically connected contents. On the other hand the video images displayed on the displays and the audio messages produce by the audio means can be relevant with each other, so as to correspond to each other or to accompany each other. For example, the video image on the display can be a video image of an advertised product, and the audio message can be a speech which explains the advertised product.

The system in accordance with the present invention includes electronic means provided in each bracelet 2. The bracelet-based electronic means include a microprocessor 5 with a memory 6 and a receiving/transmitting component or a transceiver 7 which receives corresponding signals from an internet-based control unit 8 and is connected with the display 3 and with the audio unit 4.

A user control unit 9 provided in the inventive system is connected to the microprocessor 5 and also with the display 3 and the audio unit 4. Also the electronic means include a battery 10 for battery operated functioning and a cable 11 connectable to a power source for a power supply functioning. The electronic means can also include an earphone 14.

The remotely controlling means of the inventive system include the above mentioned internet based control unit 12 and a GPS communication unit 13.

The system for supplying information to a plurality of users during mass events, for example during a sports event on a stadium in accordance with the present invention operates, in accordance with the inventive method in the following manner.

When a plurality of the users 1 attend a sports event and they enter the stadium, they are given the bracelets 2 or other articles to be worn and they wear the bracelets. Information, for example a preliminarily recorded information is stored in the memory in each bracelet, so that when a user turns on the electronic system of the bracelet, this preliminarily recorded information can become available to him/her via the video images shown in the display 3 and/or audio messages produced by the audio means 4.

The information, which is received this way by the user, not necessarily can be preliminarily recorded and stored information, but it can be also the information which is continuously or intermittently supplied by the internet-based control unit ̂ to the transceivers 7 of the bracelets and from the transceivers to the displays 3 and to the audio means 4 of the bracelets 2 over a certain time.

The user-operated control means 9 can include a plurality of buttons or a keyboard with a plurality of alpha-numerical keys, such that a user can produce on the display 3 letters, numbers, symbols, texts and other video images which he/she can compose himself/and the user can also generate words, speeches, music etc in the audio unit 4 which he/she can compose himself/herself.

The user-operated control means 9 can be also formed so as to select relevant or irrelevant video images and audio messages. For example during a sports event on a stadium a user can watch an advertising video on the display and at the same time listen commentaries of a game by a game commentator from the audio unit.

Furthermore, with the use of the GPS communication unit, different informations can be supplied to the bracelets of the users at different locations, for example in different-sectors I, II, III or even on different seats inside the same sectors.

The present invention is not limited to the details shown since various modifications and structural changes are possible without departing in any ways from the spirit of the present invention.

What is desired to be protected by Letters Patent is set forth in particular in the appended claims.

1. A system for supplying information to a plurality of users during a mass event, comprising a plurality of articles adapted to be worn by users, wherein each of said articles is provided with an electronic device having a display; and means remotely acting on said electronic devices wirelessly so that video images which carry corresponding information are produced on said displays of said electronic devices of said articles worn by the users.

2. A system as defined in claim 1, wherein said electronic device of each of said articles also has audio means which produce audio messages under the action of said remotely acting means which act on said electronic devices of said articles.

3. A system as defined in claim 2, wherein said displays of said articles produce said video images and said audio means of said articles produce said audio messages which are not relevant to each other as to their content.

4. A system as defined in claim 2, wherein said displays of said articles produce said video images and said audio means of said articles produce said audio messages which are relevant to each other as to their content.

5. A system as defined in claim 1, wherein said remotely acting means include an internet-based control unit and a GPS communication unit, allowing to display the video images on said displays of said articles on selectable locations of the users.

6. A system as defined in claim 1, wherein each of said bracelets has user-operated means, allowing to produce said video images not only under the action of said remotely acting means but also by the users via said user-operated means.

7. A method for supplying information to a plurality of users during a mass event, comprising the steps of providing a plurality of users with a plurality of articles each worn by a user; providing each article with an electronic device having a display; and remotely acting on the electronic devices wirelessly to produce on the displays of the electronic devices of the articles video images which carry corresponding information.

8. A method as defined in claim 7, further comprising providing in each of said articles audio means; and acting on the audio means by the remotely acting means so that the audio means of the electronic devices of the articles produce audio messages.

9. A method as defined in claim 8, wherein the video images produced on the displays and the audio messages produced by the audio means of the electronic devices of the articles are relevant to each other as to their content.

10. A method as defined in claim 8, wherein the video images produced by the displays and the audio messages produced by the audio means of the electronic devices of the articles are irrelevant to each other as to their content.

11. A method as defined in claim 7, further comprising producing the video images on the displays of the electronic devices of the articles on different locations selectable by an internet-based control unit and a GPS communicating unit.

12. A method as defined in claim 7, further comprising displaying the video images on the displays of the electronic devices of the articles by user-operated control means.
